(19) United States
(12) Patent Application Publication
(10) Pub. No.: US 2011/0065463 A1
(43) Pub. Date: Mar. 17, 2011

(54) APPARATUS AND METHOD OF COMPOSING A MESSAGE

(75) Inventors: Pavankumar Murli Dadlani Mahtani, Eindhoven (NL); Robert Van Herk, Eindhoven (NL); Alexander Sinitsyn, Eindhoven (NL); Eelco Dijkstra, Eindhoven (NL)

(73) Assignee: KONINKLIJKE PHILIPS ELECTRONICS N.V., EINDHOVEN (NL)

(21) Appl. No.: 12/991,920

(22) PCT Filed: May 6, 2009
(86) PCT No.: PCT/IB09/51852

§ 371 Date: Nov. 10, 2010

(30) Foreign Application Priority Data
May 13, 2008 (EP) 08156070.8

(51) Int. Cl. H04W 4/00

(52) U.S. Cl. 455/466

(57) ABSTRACT

An apparatus (100) is described for enabling the creation of a message by placing tangible objects (120) on a Scrabble® like detection grid. Each of the objects represents one or more symbols, such as a letter. The user creates the message by writing words on the grid. The apparatus (100) composes the message based on the detected identifiers of the objects (120) and their position of the grid. The user may address and send the message by placing a further tangible object (130) representing a message destination on the grid.

### TECHNICAL FIELD

The present invention relates to an apparatus and a method for composing a message.

### DESCRIPTION OF RELATED ART

Seniors generally find it difficult to use email and mobile phones because the buttons and the screen are too small, and the user interaction is too complex. Many adults or children try to teach their elderly parents or grand parents to use mobile phones for calls and text messaging, but often in vain.

The use of text messaging such as SMS or email is drastically increasing. This means that seniors, who are not capable of sending and receiving such text messages, cannot use an important means of communication, which in many cases will augment their isolation, because it is widely used by younger generations. It would be desirable to enhance connectedness between seniors, their children and their grandchildren.

The patent U.S. Pat. No. 6,983,124 B1 discloses a telecommunications device, which incorporates an RF transceiver (reader), which is configured to read associated RF transponders (tags) in order to automatically dial desired telephone numbers corresponding to the identifiers of the tags without the need for a manual user interface. The tags may be attached to or incorporated with a myriad of items, including picture frames, consumer products and packaging, advertising and promotional material, electronic business cards, record-keeping systems, etc.

So, this device provides a user friendly way of dialing a telephone number. However, it does not provide a user-friendly solution for sending of text messages and in particular for writing such text messages.

It is an object of the invention to provide an apparatus and a method for enabling the composition of a message in a user friendly way.

### SUMMARY OF THE INVENTION

Thereto, according to an aspect of the invention an apparatus according to independent claims 1 and 9, a method according to independent claims 10 and 11 and a computer program according to independent claim 12 are provided. Favorable embodiments are defined in dependent claims 2-8 and 13-14.

According to an aspect of the invention an apparatus is provided for enabling the creation of a message by placing tangible objects on a surface. Each of the objects has an identifier and represents one or more symbols, for example a single letter or figure, a group of letters, a character, a word or a phrase. Each of the objects may show which symbol it represents. The surface may be the surface of a board, similar to the one used for playing the game Scrabble®. The apparatus comprises a detector for detecting the identifiers of the objects and their position on the surface. A composer composes the message based on the detected identifiers and positions. The composed message may then be sent to another party. The apparatus enables the user to write a text message by simply putting the symbols, such as letters or words on the surface in the correct order, in this way creating the text of the message. The use of buttons, which elderly people often find difficult, is hereby avoided. The message, which may be an SMS, email or any other type of message, may then be transmitted to a receiving party. Thereto, the apparatus may be coupled to a mobile phone or email system. Alternatively, the means for message transmission may be integrated in the apparatus itself.

According to an embodiment of the invention, the composer is adapted to identify the symbol or symbols represented by each object based on the detected identifier thereof and compose a text message by inserting the symbol or symbols into the message in the order corresponding to their positions on the surface. As a result a text message is created which may be readily displayed at a receiving end in the same way as a SMS or E-mail message, which has been composed in a conventional way. So, at the receiving end a standard mobile phone or computer can be used to receive and display the message.

According to an alternative embodiment of the invention, the composer composes the message by inserting the identifiers in the message in the order corresponding to their positions on the surface. At the receiving end, the message is transformed to a text format by identifying the symbol or symbols corresponding to the identifiers in the received message and inserting the symbol or symbols into the text message. In this way, the message that is sent over the communication network is not readable for third parties, enhancing privacy.

According to a further embodiment of the invention, the apparatus enables the addressing of the message by placing a further tangible object on the surface, the object having an identifier and representing a destination of the message. The detector is adapted for detecting the identifier of the further object. This enables the user to select the destination of the message by simply placing the corresponding object on the surface. A specific tangible object should be provided corresponding to every destination person that the user frequently sends a message to. Each of the further objects shows which destination it represents, for example by a picture of the concerned person printed on the object.

The identifier of the further object may be the network address of the destination person. In this way, the apparatus can simply use the identifier to address the message. However, in case that the memory of the further object is very small there may not be enough space for storing a long identifier such as an international phone number or a long E-mail address. In that case, the identifier of the further object may be a very brief one and is matched to the corresponding network address in a matching table. In this case, the apparatus comprises a retriever for retrieving the network address corresponding to the destination of the message from the matching table, based on the identifier of the further object. The network address may then be added in the message, so that the message may be correctly routed to its destination. An additional advantage of this embodiment is that, in case that the network address of a certain destination changes, only the matching table has to be updated and the identifier in the memory of the further object corresponding to this destination remains the same and needs not to be updated.

According to a still further embodiment of the invention, the tangible objects are implemented as radio-frequency identification (RFID) tags and the detector comprises a radio frequency identification detection grid for detecting the positions and the identifiers of the tags. RFID technology is cheap and reliable and therefore very suitable to be used to implement the message composing apparatus.

According to a yet further embodiment of the invention, the detection grid forms the surface and is divided in a plurality of spaces, on each of which a single tangible object may be placed. In this way, guidance is provided to the user for collocation of the tangible objects on the surface.

The composer may be adapted to verify blank spaces on the detection grid and to include blank spaces in the composed message. In case that there are multiple consecutive blank spaces, the composer preferably includes only a single one in the composed message. In this way, spaces can be inserted in the message in a user friendly way but the message is kept readable.

According to a further aspect of the invention, a method is provided for composition of a message, which is created by placing tangible objects on a surface, each of the objects having an identifier and representing one or more symbols, comprising the steps of:

detecting the identifiers of the objects and their position on the surface, and

composing the message based on the detected identifiers and positions.

According to a still further aspect of the invention, a method is provided comprising the steps of:

receiving a message from a sender apparatus, the received message comprising the identifiers of the tangible objects used to create the message at the sender apparatus, and

transforming the received message into a text message by inserting the symbol or symbols corresponding to the identifiers into the text message.

According to a still further aspect of the invention, a computer program is provided comprising computer program code means adapted to perform the step of composing a text message, which is created by placing tangible objects on a surface, each of the objects having an identifier and representing one or more symbols, based on the detected identifiers of the objects and their positions, when said program is run on a computer.

The computer program may be embodied on a computer readable medium or a carrier medium may carry the computer program.

These and other aspects of the invention will be apparent from and elucidated with reference to the embodiments described hereinafter.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 shows the composition of a text message using an apparatus according to an embodiment of the present invention.

FIG. 2 shows a functional block diagram of an apparatus according to an embodiment of the present invention at the sending end.

FIG. 3 shows a flow chart of steps performed by the apparatus depicted in FIG. 2 according to an exemplary embodiment.

FIG. 4 shows a flow chart of steps performed by the apparatus depicted in FIG. 2 according to an alternative embodiment.

FIG. 5 shows a functional block diagram of an apparatus according to an embodiment of the present invention at the receiving end.

FIG. 6 shows a flow chart of steps performed by the apparatuses depicted in FIGS. 2 and 5 according to a further alternative embodiment.

Throughout the figures like reference numerals refer to like elements.

### DETAILED DESCRIPTION OF THE PRESENT INVENTION

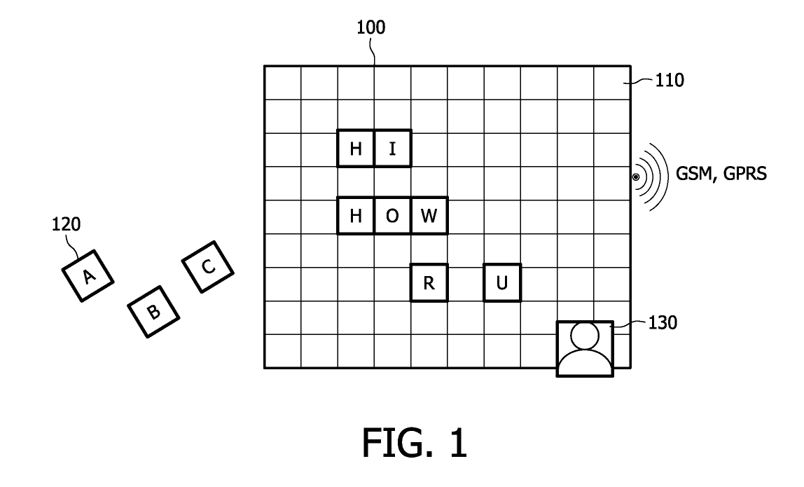

Referring to FIG. 1, the composition of a message by a user with an apparatus 100 according to an exemplary embodiment of the invention will be described. The apparatus 100 comprises a radio frequency identifier (herein after RFID) detector grid 110, divided in a plurality of areas or spaces, like a Scrabble® board. The user composes the message by using RFID objects 120 (tags), each representing a letter, which is shown on the tag. By placing each of the letters on a space of the detector grid, words are created. Instead of representing a single letter the tags may represent groups of letters or words, or also other symbols, such as figures, characters or punctuation marks. After the creation of the message the user addresses and sends the message by simply putting a further object 130 (tag), on a part of the detector grid dedicated for this purpose, for example a corner space. The user has a specific tag for each destination that he/she often sends messages to. A picture of the corresponding destination person may be shown on the tags 130.

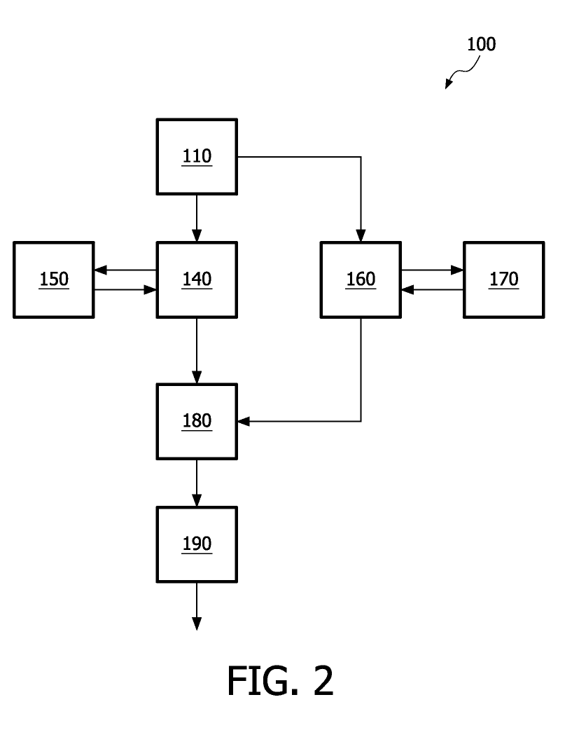

The tags 120 representing letters and tags 130 representing destinations have mutually different identifiers. The detector grid 110 detects the identifiers of the tags 120,130 placed on its surface and the position thereof In case that the position of the tag does not correspond to a space dedicated to addressing and transmission of the message, the identifier of the tag and its position are forwarded to a composer 140, shown in FIG. 2. The composer 140 retrieves the symbol that the tag represents from a matching table 150, which comprises the mapping of the tag-identifiers to the symbols. Based on the retrieved symbols and their positions on the detector surface, the composer composes the text message. The composer may verify blank spaces on the detection grid. Multiple consecutive spaces are treated as a single one, so in case of the message as composed in the example shown in FIG. 1, wherein there are multiple spaces between the words, only a single one is included in the composed message. This eases composition, but keeps the message readable. In case that the position of the tag corresponds to a space dedicated to addressing of the message, the detector forwards the identifier to a retriever 160. The retriever retrieves the network address corresponding to the identifier, for example a telephone number or an email address, from a matching table 170. The matching table comprises the mapping of the tag-identifiers to the network addresses. The network address is added to the message, for example to the message header, by an adder 180. The message is sent to the destination by a sender 190 for example as an SMS message or email.

It is possible to store the complete network address of the destination, which a tag 130 represents, in the memory of the RFID tag as identifier. In that case the retriever 160 and the matching table 170 can be omitted and the identifier of the tag (i.e. the network address of the destination to which it corresponds) is directly passed on from the detector grid 110 to the adder 180.

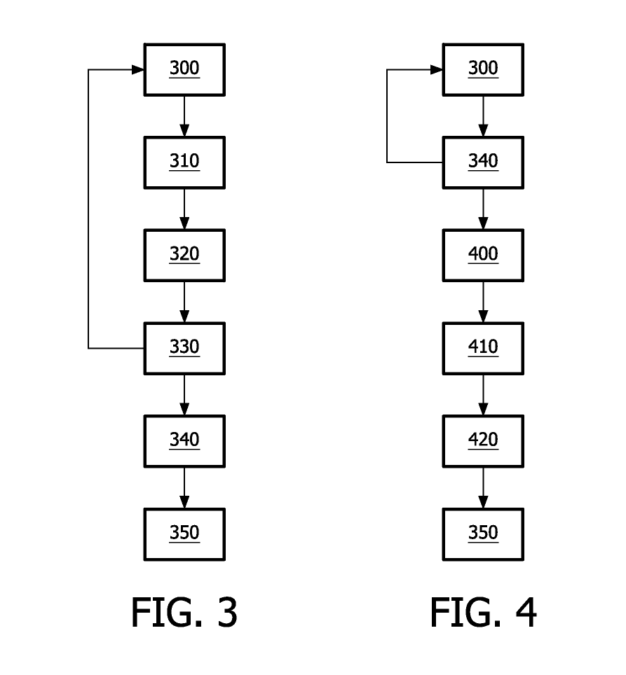

Now, with reference to FIGS. 3 and 4 flow charts of steps performed by the apparatus depicted in FIG. 2 according to two exemplary embodiments will be described.

The user starts composing the message by placing a tagged letter (or a tag representing a phrase or word) on the RFID detector grid (step 300). The RFID detector grid detects the identifier and the position of the tag (step 310). The composer retrieves the letter by means of the identifier of the tag (step 320) and composes the message (step 330) by verifying blank spaces on the grid and making words. Steps 300-330 are repeated as long as the user continues placing tags on the RFID-grid. When the user places a destination tag on the RFID detector grid (step 340), the network address is derived from the tag ID, added into the message and the message is sent to the network address via GSM or Internet (step 350). So, according to the exemplary embodiment depicted in FIG. 3, the apparatus composes the message while the user places the tags on the RFID grid.

In the exemplary embodiment depicted in FIG. 4, the apparatus postpones the composition of the message until the user finishes the process of placing tags on the RFID grid (step 300). When the user places a destination tag on the RFID detector grid (step 340), the message composition starts: the RFID detector grid detects the positions and identifiers of all tags placed on the grid (step 400). The composer retrieves all letters by means of the identifiers of the tags (step 410) and composes the message (step 420) by verifying blank spaces on the grid and making words. The network address is derived from the tag ID of the destination tag, added into the message and the message is sent to the network address via GSM or Internet (step 350).

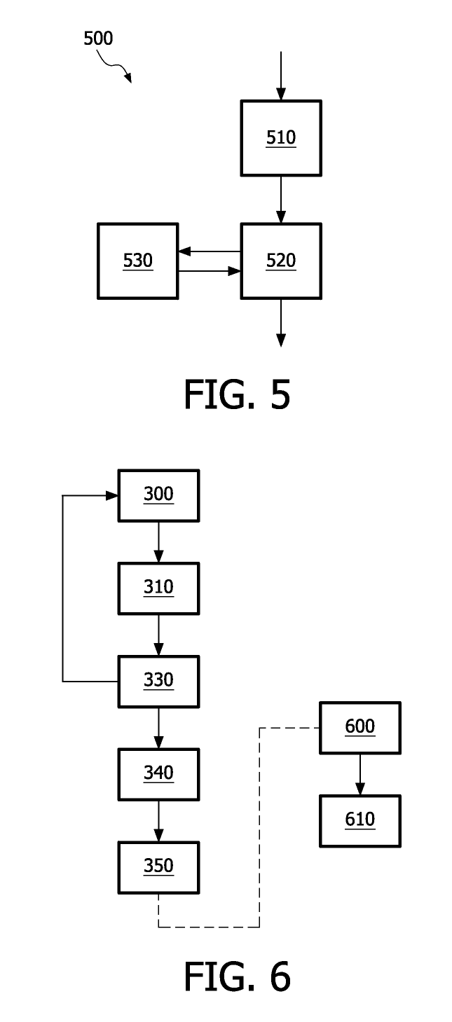

According to an alternative embodiment, the matching table 150 is omitted in the sending apparatus 100. The composer 140 composes the message by placing the detected identifiers of the tags placed on the RFID detector grid in the order defined by their position on the grid. The message comprising the identifiers is sent to its destination in the same way as described with reference to the exemplary embodiments herein above. The sent message does not have a text format but simply consists of the identifiers of the tags that were used to compose it. As a result third parties cannot read the message and privacy/security is enhanced. As shown in FIG. 5, the apparatus 500 at the receiving end receives the message by means of the receiver 510. A transformer 520 transforms the message into a text format by retrieving the symbol or symbols corresponding to the identifiers in the received message from a matching table 150.

This is also shown in the flowchart depicted by FIG. 6, which shows the steps 300,310,320,340,350 performed by the sending apparatus and the step 600 of receiving the message and the step 610 of transforming the message into text performed by the receiving apparatus.

While the invention has been illustrated and described in detail in the drawings and foregoing description, such illustration and description are to be considered illustrative or exemplary and not restrictive; the invention is not limited to the disclosed embodiments.

For example, instead of using RFID technology for the detection of the objects other suitable technologies may be used, such as infrared technologies. Furthermore, the present invention is not limited to the composition of messages for SMS and email but it is applicable to any kind of messages. Furthermore, alternative ways of addressing the message may be envisaged, for example by touching a picture corresponding to a message destination on a touch screen.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. Apparatus (100) for enabling the creation of a message by placing tangible objects (120) on a surface, each of the objects having an identifier and representing one or more symbols, comprising:
a detector (110) for detecting the identifiers of the objects and their position on the surface, and
a composer (140) for composing the message based on the detected identifiers and positions.

2. Apparatus according to claim 1 wherein the composer is adapted to identify the symbol or symbols represented by each object based on the detected identifier thereof and to compose a text message by inserting the symbol or symbols into the message.

3. Apparatus according to claim 1 furthermore enabling the addressing of the message by placing a further tangible object (130) on the surface, the object having an identifier and representing a destination of the message, wherein the detector is adapted for detecting the identifier of the further object.

4. Apparatus according to claim 3 furthermore comprising a retriever (160) for retrieving a network address corresponding to the destination of the message based on the identifier of the further object.

5. Apparatus according to claim 4 furthermore comprising an adder (180) for adding the network address in the message.

6. Apparatus according to claim 1 wherein the tangible objects are radio-frequency identification tags and the detector comprises a radio frequency identification detection grid for detecting the positions and the identifiers of the tags.

7. Apparatus according to claim 6 wherein the detection grid forms the surface and is divided in a plurality of spaces, on each of which a single tangible object may be placed.

8. Apparatus according to claim 7 wherein the composer is adapted to verify blank spaces on the detection grid and to include blank spaces in the composed message.

9. Apparatus (500) comprising: a receiver (510) for receiving a message from a sender apparatus (100), the received message comprising the identifiers of tangible objects (120) used to create the message at the sender apparatus, the apparatus (500) further comprising: a transformer (520) for transforming the received message into a text message by inserting the symbol or symbols corresponding to the identifiers into the text message.

10. Method for composition of a message, which is created by placing tangible objects on a surface, each of the objects having an identifier and representing one or more symbols, comprising the steps of:
detecting (310) the identifiers of the objects and their position on the surface, and
composing (330) the message based on the detected identifiers and positions.

11. Method comprising the steps of:
receiving (600) a message from a sender apparatus, the received message comprising the identifiers of tangible objects used to create the message at the sender apparatus, and
transforming (610) the received message into a text message by inserting the symbol or symbols corresponding to the identifiers into the text message.

12. A computer program comprising computer program code means adapted to perform the step of composing a text message, which is created by placing tangible objects on a surface, each of the objects having an identifier and representing one or more symbols, based on the detected identifiers of the objects and their positions, when said program is run on a computer.

13. A computer program as claimed in claim 12 embodied on a computer readable medium.

14. A carrier medium carrying the computer program of claim 12.
